(19) United States
(12) Patent Application Publication
(10) Pub. No.: US 2026/0087332 A1
(43) Pub. Date: Mar. 26, 2026

(54) SPARSE CODEC FOR NEURAL NETWORK

(71) Applicant: MOFFETT INTERNATIONAL CO., LIMITED, Kowloon (HK)

(72) Inventor: Changxu ZHANG, SANTA CLARA, CA (US)

(21) Appl. No.: 18/897,242

(22) Filed: Sep. 26, 2024

(51) Int. Cl. G06N 3/0495

(52) U.S. Cl. CPC G06N 3/0495

(57) ABSTRACT

An advanced processor is disclosed for efficient handling of sparse tensor data. The processor comprises an input buffer configured to receive an input tensor, a gather circuit that collects high-magnitude tensor data from a dense tensor to form a condensed tensor, and a scatter circuit that distributes tensor data from a condensed tensor into a sparse uncondensed tensor based on a given mask. The processor is configured to perform sparse encoding, generating a sparse representation of the input tensor that includes: (1) the condensed tensor containing high-magnitude tensor data gathered by the gather circuit, and (2) a sparse mask indicating the position information of high-magnitude tensor data in the input tensor. Additionally, the processor performs sparse decoding by scattering the condensed tensor into the sparse uncondensed tensor using the scatter circuit and the sparse mask.

### TECHNICAL FIELD

The present invention pertains to the field of neural networks and, more specifically, to methods and processors for implementing an efficient codec for neural network sparsification.

### BACKGROUND

Neural networks have become a cornerstone of modern artificial intelligence (AI) systems, enabling advancements in areas such as computer vision, natural language processing, and autonomous systems. These networks are typically characterized by large numbers of parameters (e.g., weights) and intermediate computational states (e.g., activations), which require significant computational and memory resources.

To address the challenges posed by the large-scale nature of neural networks, various sparsification techniques have been developed. Sparsification involves reducing the number of non-zero elements in weight tensors and/or activation tensors, thereby lowering the computational burden and memory requirements.

Both sparse encoding and sparse decoding are essential in neural network computation because they enable efficient processing while ensuring compatibility with standard neural network operations. Sparse encoding allows for the reduction of unnecessary computations and data transfers, significantly improving the efficiency of neural network execution. On the other hand, sparse decoding is necessary to restore the original structure of tensors when interacting with components or operations that require dense data formats. For instance, some neural network operations (like max pooling, average pooling, etc.) may require dense tensors as input, and some hardware accelerators or software frameworks may not natively support sparse computations. Without both processes, it would be challenging to fully exploit the benefits of sparsity while maintaining the flexibility and accuracy required for various neural network tasks.

While these sparsification techniques offer substantial benefits in terms of efficiency, the existing hardware and software solutions present significant limitations. Many current neural network processors are optimized for dense operations or require separate accelerators for sparse encoding and decoding.

There is a growing need for a unified hardware configuration that can efficiently support both directions of sparsification: sparsification and de-sparsification using the same piece of hardware. To address these challenges, this disclosure introduces a unified hardware implementation supporting both sparse encoding and sparse decoding, which are critical for optimizing the performance and resource utilization of neural networks, particularly in resource-constrained environments.

### SUMMARY

Various embodiments of the present specification may include processors and systems implementing a unified hardware architecture supporting both sparse encoding and sparse decoding. A system composed of one or more computers can be configured to perform specific operations or actions by installing software, firmware, hardware, or a combination of these elements. This configuration enables the system to carry out the designated actions. Similarly, computer programs can be designed to perform particular operations by including instructions that, when executed by data processing apparatus, prompt the apparatus to execute these actions.

In one aspect, a processor is described. The processor includes an input buffer configured to receive an input tensor; a gather circuit configured to gather high-magnitude tensor data from a given dense tensor into a condensed tensor; and a scatter circuit configured to scatter tensor data from a given condensed tensor into a sparse uncondensed tensor based on a given mask; where the processor is configured to (e.g., through an encoding circuit coupled to the gather circuit): perform sparse encoding to generate a sparse representation of the input tensor, where the sparse representation includes (1) the condensed tensor generated using the gather circuit based on the high-magnitude tensor data of the input tensor and (2) a sparse mask indicating position information of high-magnitude tensor data in the input tensor; and perform sparse decoding (e.g., through a decoding circuit coupled to the scatter circuit): to scatter the condensed tensor in the sparse representation into the sparse uncondensed tensor using the scatter circuit based on the sparse mask, where the sparse uncondensed tensor has same dimensions as the input tensor.

In some embodiments, a memory footprint for storing the sparse representation of the input tensor is less than a memory footprint for storing the input tensor.

In some embodiments, the high-magnitude tensor data in the condensed format is stored using a high bit-depth to achieve high-precision storage, and the low-magnitude tensor data in the bitmask is stored using a reduced bit-depth to achieve low-precision storage, trading off precision for increased memory efficiency.

In some embodiments, the processor further includes a transmitter configured to transmit the sparse representation of the input tensor to a Sparse Processing Unit (SPU) for neural network computation, or to another processor in the array of processors for computation or decoding.

In some embodiments, the sparse representation further includes quantization parameters used in encoding data in the input tensor.

In some embodiments, the encoding circuit is further configured to: sort tensor data in the input tensor to identify the high-magnitude tensor data and the low-magnitude tensor data; generate a temporary bitmask indicating position information of the high-magnitude tensor data in the tensor; determine a first set of quantization parameters for the high-magnitude tensor data, and a second set of quantization parameters for the low-magnitude tensor data; generate, using the gather circuit, the condensed tensor comprising the high-magnitude tensor data quantized using the first set of quantization parameters; generate the sparse mask representing the low-magnitude tensor data based on the temporary bitmask and the second set of quantization parameters; and output the condensed tensor, the sparse mask, the first set of quantization parameters, and the second set of quantization parameters as the sparse representation of the tensor.

In some embodiments, to generate the condensed tensor comprising the high-magnitude tensor data quantized using the first set of quantization parameters, the encoding circuit is further configured to: feed the input tensor and the temporary bitmask to the gather circuit to gather the high-magnitude tensor data; and quantize the high-magnitude tensor data by applying the first set of quantization parameters to the high-magnitude tensor data.

In some embodiments, to generate the sparse mask representing the low-magnitude tensor data based on the temporary bitmask and the second set of quantization parameters, the encoding circuit is further configured to: quantize the low-magnitude tensor data in the tensor by applying the second set of quantization parameters to the tensor to obtain a temporary tensor, where tensor data in the temporary tensor uses a reduced bit-depth than tensor data in the tensor; and merge the temporary tensor with the temporary bitmask to obtain the bitmask representing the low-magnitude tensor data in the tensor.

In some embodiments, the processor further includes a quant buffer configured to receive quantization parameters, where: the quantization parameters received by the quant buffer include a first set of quantization parameters corresponding to the condensed tensor, and a second set of quantization parameters corresponding to the sparse mask.

In some embodiments, the decoding circuit is further configured to: dequantize the condensed tensor to obtain a dequantized high-magnitude tensor using the first set of quantization parameters; dequantize the sparse mask to obtain a dequantized low-magnitude tensor using the second quantization parameters; and feed the dequantized high-magnitude tensor and the dequantized low-magnitude tensor to the scatter circuit to obtain a restored version of the input tensor.

In some embodiments, to dequantize the condensed tensor and the sparse mask, the decoding circuit is further configured to: increase a bit-depth of tensor data in the condensed tensor and the sparse mask, where the increased bit-depth is same as a bit-depth of tensor data in the input tensor.

In some embodiments, each entry in the sparse mask includes two or more bits, with a first bit representing a sign of a corresponding tensor data, and the first bit is combined with each of subsequent bits of the two or more bits to implement multi-ternary representation of quantized tensor data.

In another aspect, a method for sparse encoding a tensor is described. The method may include sorting tensor data in the tensor to identify high-magnitude tensor data and low-magnitude tensor data; generating a temporary bitmask for the tensor indicating position information of the high-magnitude tensor data in the tensor; determining a first set of quantization parameters for the high-magnitude tensor data, and a second set of quantization parameters for the low-magnitude tensor data; generating, using a gather circuit, a condensed tensor comprising the high-magnitude tensor data based on the temporary bitmask; quantizing the condensed tensor using the first set of quantization parameters; generating a sparse mask representing the low-magnitude tensor data based on (1) the temporary bitmask and (2) the second set of quantization parameters; and outputting the quantized condensed tensor, the sparse mask, the first set of quantization parameters, and the second set of quantization parameters as a sparse representation of the tensor, replacing the tensor in neural network computations.

In yet another aspect, a method for sparse decoding a tensor is described. The method may include obtaining, from a shared memory, the sparse representation of the tensor that includes: a condensed tensor representing quantized high-magnitude tensor data from the tensor, a decoding bitmask comprising (1) original position information of the high-magnitude tensor data in the tensor and (2) quantized low-magnitude tensor data from the tensor, and a set of quantization parameters; dequantizing, using the set of quantization parameters, the condensed tensor to obtain a dequantized high-magnitude tensor; dequantizing, using the set of quantization parameters, the decoding bitmask to obtain a dequantized low-magnitude tensor; generating, using a scatter circuit, a sparse uncondensed tensor based on the dequantized high-magnitude tensor and the decoding bitmask; merging the sparse uncondensed tensor with the dequantized low-magnitude tensor to obtain an approximation of the tensor.

Other embodiments of this application may include corresponding computer systems, apparatus, and computer programs recorded on one or more storage devices, each configured to perform these methods.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1A illustrates an exemplary system diagram of a neural network processing unit.

FIG. 1B illustrates an example Processing Entity (PE) in the neural network processing unit.

FIG. 2A illustrates an example sparse codec supporting both sparse encoding and sparse decoding, in accordance with various embodiments.

FIG. 2B illustrates an example system diagram of a PE with the sparse codec, in accordance with various embodiments.

FIG. 3 illustrates a sparse encoding process using the PE with the sparse codec, in accordance with various embodiments.

FIG. 4 illustrates a sparse decoding process using the PE with the sparse codec, in accordance with various embodiments.

FIGS. 5A and 5B illustrate exemplary gather and scatter processes using the PE with the sparse codec, in accordance with various embodiments.

FIG. 5C illustrate an example data format of the bitmask of the sparse codec, in accordance with various embodiments.

FIG. 6 illustrate an example method of sparse encoding using the sparse codec, in accordance with various embodiments.

FIG. 7 illustrate an example method of sparse decoding using the sparse codec, in accordance with various embodiments.

### DETAIL DESCRIPTION OF THE EMBODIMENTS

Embodiments described herein provide methods, systems, apparatus for implementing a sparse codec for sparsifying and de-sparsifying tensors for neural network computations and storage.

As mentioned in the background section, sparsification in neural networks involves reducing the number of non-zero elements in weight tensors or activation tensors, thereby lowering the computational burden and memory requirements. The sparsity of neural networks can be achieved through methods such as pruning, quantization, and regularization. These methods reduce the density of neural network tensors, leading to more efficient model execution.

In certain applications, sparsification eliminates zero-valued elements while retaining non-zero elements. In other applications, sparsification removes low-magnitude elements and preserves high-magnitude elements (e.g., by applying a value threshold to differentiate between low-and high-magnitude elements). For simplicity, the following description uses the zero/non-zero example. A person skilled in the art would be able to apply the described process to high-magnitude/low-magnitude scenarios.

This disclosure uses distinct types of tensors to help describe the invention, such as dense tensors, sparse tensors, condensed tensors, and sparse uncondensed tensors.

A dense tensor refers to a tensor in its original size, characterized by the number of elements and the bit-depth (precision) of these elements as received from upstream or downstream processing engines. The dense tensor may include high-magnitude data and low-magnitude data. When a dense tensor contains a large number of zero-valued data, it is called a sparse tensor.

The sparse tensor may be represented and stored in different data formats using a combination of a condensed tensor, a bitmask, and optional quantization information. A condensed tensor represents a compressed version of a given tensor, the bitmask maps the data in the condensed tensor with the original tensor, and the quantization information includes quantization parameters used when generating the condensed tensor from the original tensor.

In a narrow-sense sparse representation, the sparse representation of a sparse tensor may include a condensed tensor and a bitmask. The condensed tensor only stores non-zero elements from a sparse tensor, and the bitmask uses binary values to indicate the original positions of the non-zero elements in the given tensor. The condensed tensor in combination of the bitmask can be used to restore the given tensor. The restoration may be necessary for certain tensor operations (e.g., max or average pooling) or hardware processing units.

In a more general-sense sparse representation, the sparse representation of a sparse tensor may include a condensed tensor and a bitmask. The condensed tensor stores high-magnitude elements in the original tensor (e.g., a dense tensor). The bitmask uses multi-bits values to indicate not only the original positions of the high-magnitude elements in the original tensor, but also encoded value information of the low-magnitude elements in the original tensor. The “high-magnitude elements” refer to elements that exceed a value threshold, indicating significance of these elements for the tensor computation. The condensed tensor in combination of the multi-bit bitmask can be used to restore the given tensor.

In some embodiments, if quantization is performed when converting the given tensor into the corresponding condensed tensor, the quantization parameters (e.g., scale and bias) may be stored as part of the sparse representation in addition to the condensed tensor and the bitmask. While quantization reduces the data precision, the quantization parameters may be used to reverse (to some extent) the data precision when converting the condensed tensor back to its dense format.

The sparse uncondensed tensor is an expanded version of the condensed tensor.

Elements from the condensed tensor are scattered and distributed into this larger tensor, which contains more positions or “spots” than the condensed tensor. Since the elements from the condensed tensor occupy only a subset of these spots, the remaining positions are filled with zero-valued elements, rendering the uncondensed tensor sparse.

In some scenarios, the dense tensor and the sparse uncondensed tensor share the same size and dimensions, while the condensed tensor has a smaller size. The bit-depth of the dense tensor is higher than that of the condensed tensor. The bit-depth of the sparse uncondensed tensor may remain the same as that of the dense tensor.

Additionally, the term “sparse representation” of a dense tensor used in this disclosure refers to a group of data generated through the sparsification of the dense tensor.

In neural networks sparsification, sparse encoding is a process to convert a dense tensor (either a weight tensor or an activation tensor) into a sparse representation. The sparse representation of the dense tensor may include a condensed tensor, a low-bit bitmask, and optional quantization parameters. This condensed tensor captures only the non-zero elements, significantly reducing the amount of data that needs to be processed or transmitted. The low-bit bitmask uses low bit-depth to represent the low magnitude elements. The optional quantization parameters include the parameters used during the quantization (if any) of the dense tensor, and will be used to restore the sparse representation back to the dense format (i.e., as a result of the sparse decoding). Sparse encoding is particularly beneficial for improving computational efficiency and reducing memory usage in scenarios where the majority of the tensor elements are zeros.

However, the sparsification process introduces new challenges that must be addressed to fully exploit the benefits of sparse computing. Not all neural network operations or upstream hardware/accelerators are designed to handle sparse data natively. Many standard operations, such as max pooling and average pooling, as well as interactions with dense layers, require tensors in their original dense format. To address this need, sparse decoding is required. Sparse decoding is the reverse of sparse encoding; it reconstructs the dense tensor from its sparse representation by reintroducing the low-magnitude elements (e.g., zeros) at their appropriate positions. This step is crucial for ensuring compatibility with operations that expect dense input tensors and for maintaining the integrity of the computational process within the network.

Moreover, many existing hardware accelerators and software frameworks may lack native support for sparse operations, necessitating the use of sparse decoding to convert sparse tensors back to their dense forms. This ensures that the neural network can function correctly on a wide range of computing platforms. Additionally, the ability to restore the original dense structure of tensors is important for tasks such as model inspection, analysis, and further processing.

In the sparse encoding process, it is common practice to prune low-magnitude tensor data by marking those below a certain threshold as zeros. Traditional sparse encoders typically retain only the positions of the non-zero tensor data after pruning, completely discarding the information related to the pruned low-magnitude values in order to save spaces. However, this approach is insufficient when sparse decoding is required later in the pipeline. The goal of sparse decoding is to reconstruct the dense tensor as accurately as possible to its original form, making it crucial that the sparse encoding process does not simply abandon the pruned values. Instead, the sparse encoding process needs to not only retain a minimal memory footprint for these pruned values but also store enough information to allow the sparse decoding process to approximate the original dense tensor without significant loss of accuracy. This balance between reducing memory usage and preserving data integrity is essential for ensuring that the sparsification and subsequent de-sparsification processes do not degrade the performance of the neural network.

In this disclosure, a unified hardware configuration is introduced to facilitate both directions of neural network sparsification—specifically, sparse encoding and sparse decoding—using the same piece of hardware. This hardware configuration can be implemented as Processing Entities (PEs) within a PE array or processors within a processor array, which are commonly utilized in neural network environments for parallel processing. By enabling some or all of the PEs or processors within these arrays to support both sparse encoding and decoding, the proposed configuration significantly enhances in-core computational efficiency by focusing only on the non-zero tensor data within the sparse-encoded tensors. Additionally, it reduces the need for extensive data exchange between cores by transmitting the compact, sparse-encoded tensors and performing the necessary sparse decoding locally when required. This dual-functionality approach optimizes resource usage and minimizes data transfer overhead, thereby improving the overall performance and scalability of neural network computations.

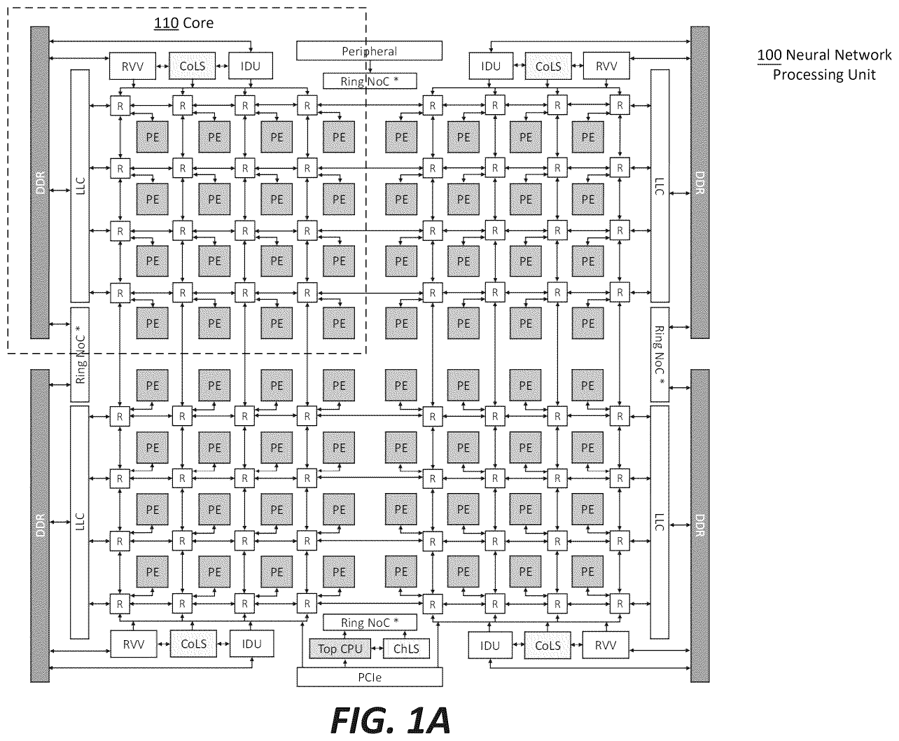

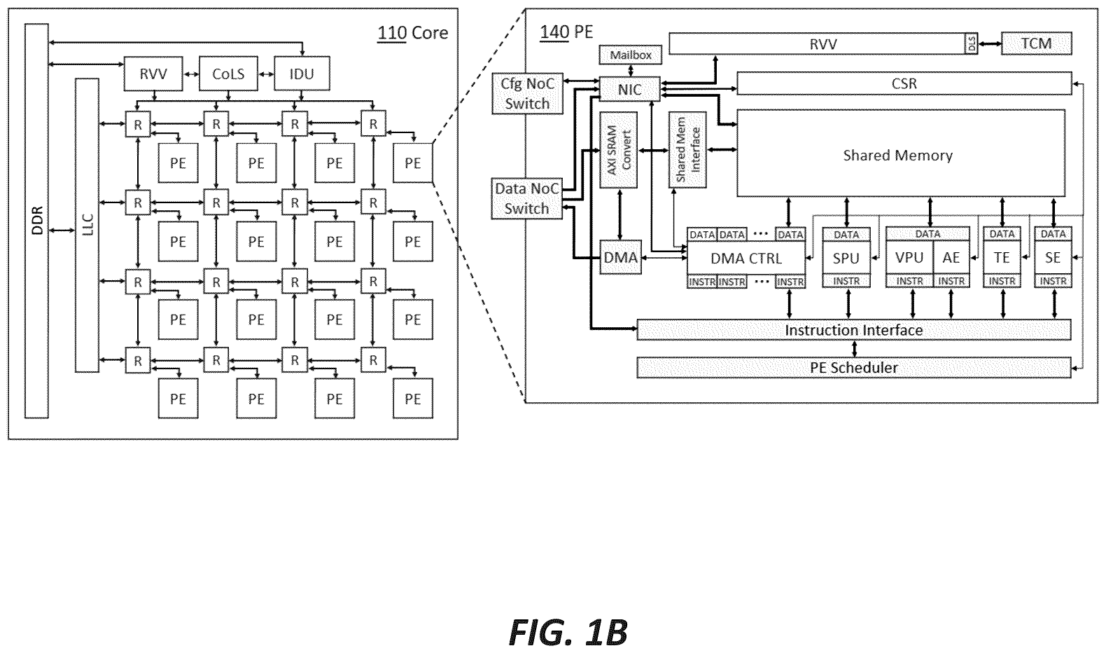

FIG. 1A illustrates an exemplary system diagram of a neural network (NN) processing unit 100. The neural network processing unit 100 in FIG. 1A may refer to a neural network accelerator or an NPU, e.g., a specialized microprocessor designed to accelerate machine learning and artificial intelligence (AI) tasks. Unlike traditional CPUs (Central Processing Units) and GPUs (Graphics Processing Units), accelerators or NPUs are optimized specifically for the neural network operations such as convolution computations and vector operations.

The NN processing unit 100 illustrated in FIG. 1A includes a plurality of Processing Entities (PEs) that are designed to provide maximum parallelism to accelerate neural network operations. These PEs are organized in a 2D mesh network and interconnected via a network of routers (denoted as “R” in FIG. 1A). Additionally, the NN processing unit 100 incorporates double data rate (DDR) memory modules and caches, such as the last-level cache (LLC), to support efficient data storage and retrieval. The NN processing unit 100 in FIG. 1A is merely illustrative, and may comprise more, fewer, or alternative components. The accelerator 100 may be designed as a reconfigurable device such as a field-programmable gate array (FPGA), or an application-specific integrated circuit (ASIC). The sparse codec introduced in this disclosure may be implemented in a PE.

In some embodiments, to optimize resource utilization and enhance the parallel processing capabilities of the NN processing unit 100, the PEs within the 2D mesh network may be divided into multiple sections, with each section referred to as a core. As illustrated in FIG. 1, every group of 16 PEs (arranged in a 4×4 grid) constitutes a core, resulting in a total of four cores across the 64 PEs in the NN processing unit 100. Each core is equipped with dedicated DDR memory, LLC, and control circuits, including a RISC-V Vector Unit (RVV), responsible for vector processing, Core-Level Scheduler (CoLS), which manages the execution and synchronization of multiple PEs, and an Instruction Dispatch Unit (IDU), which allocates instructions to various execution units within the accelerator. This architecture enables all four cores 110 (i.e., the four PE groups) to operate concurrently, ensuring efficient parallel processing.

In some embodiments, these cores 110 are further organized into a Network-on-Chip (NoC) for inter-core communication. For instance, in FIG. 1A, the four groups of PEs are arranged as a ring NoC, facilitating seamless communication between cores and enhancing overall computational throughput. The ring NoC architecture includes a circular arrangement of cores 110, where data packets travel along a unidirectional or bidirectional ring, passing through each core 110 until they reach their destination. The ring NoC may be used for data communication between DDRs and PCIe or for PEs to read data from DDR belonging to other cores. In addition to the ring NoC, the PEs may be arranged as a 2D mesh NoC, managing the data communication between PEs.

Furthermore, the ring NoC architecture in FIG. 1A is scalable, allowing additional cores or PEs to be easily added to the ring without significantly increasing the complexity of the network. This flexibility supports the expansion of the NN processing unit to accommodate larger neural network models or additional computational tasks as needed.

The NN processing unit 100 illustrated in FIG. 1A may interact with an external (host) CPU through a peripheral component interconnect express (PCIe). The NN processing unit 100 illustrated in FIG. 1A may further include an internal CPU to orchestra the cores with instructions, and a chip-level scheduler (ChLS).

FIG. 1B illustrates an example Processing Entity (PE) 140 in the neural network processing unit. The PE 140 is an example of a PE within core 110 from FIG. 1A. The internal components of PE 140 depicted in FIG. 1B are for illustrative purposes, and the actual implementation may include additional, fewer, or alternative components depending on the specific design requirements.

In some embodiments, the PE 140 includes two NoC switches: a Data NoC Switch and a Cfg NoC Switch, both used to facilitate communication with other cores on the NoC. The Data NoC Switch is responsible for transmitting high-bandwidth data and instructions, ensuring efficient communication of tensor data and processing commands across the network. The Cfg NoC Switch is dedicated to handling configuration data, including parameters and setup information for the core and its functional modules. The wired connections to the Data NoC Switch are typically of higher bandwidth compared to those of the Cfg NoC Switch, reflecting the heavier data traffic load on the data path.

Additionally, PE 140 may include a scheduler that manages instruction issuance through an instruction interface, triggering various functional modules. These modules include the DMA (Direct Memory Access) module, which facilitates high-speed data transfer between memory and processing units without burdening the central processing core. The Sparse Processing Unit (SPU) performs tensor multiplication. The Vector Processing Unit (VPU) handles vectorized operations. The Activation Engine (AE) applies activation functions, including ReLU, sigmoid, or softmax, introducing non-linearity into the neural networks. The Transpose Engine (TE) performs tensor transposition, often required in matrix multiplications and other tasks that involve reordering data dimensions. Finally, the Sorting Engine (SE) is responsible for sorting tensor elements, particularly useful in identifying and isolating high-magnitude values for optimization and pruning in sparse computations. These functional modules efficiently access shared memory, allowing seamless data transfer and interaction between them to ensure smooth operation.

Furthermore, PE 140 incorporates a local RISC-V Vector (RVV) processing unit, such as a single-core RVV, which is optimized for executing vectorized instructions for neural network tasks. The RVV is coupled with TCM (Tightly Coupled Memory), a high-speed, low-latency memory directly connected to the PE. This TCM allows the PE to store critical data and intermediate results for rapid access, minimizing latency and ensuring efficient execution of compute-intensive tasks such as matrix operations, convolutions, and tensor manipulations.

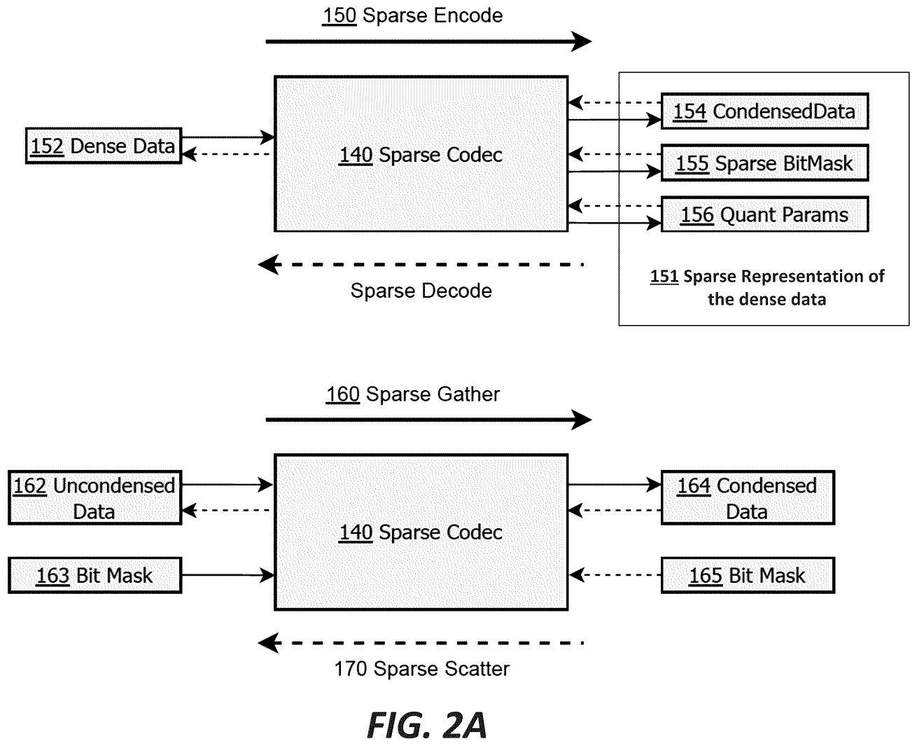

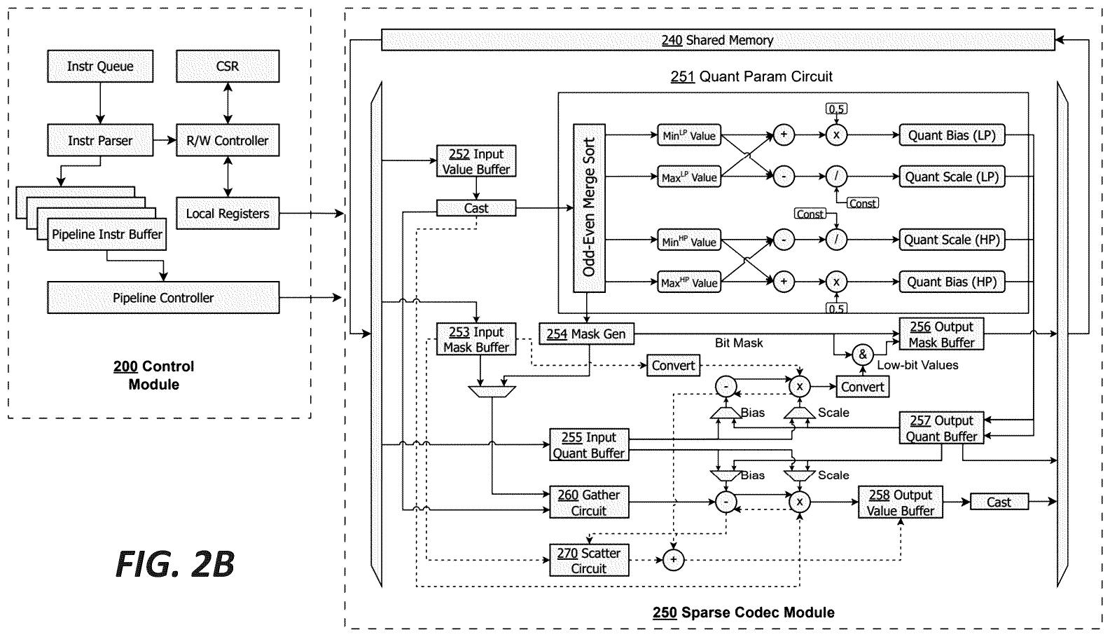

FIG. 2A illustrates an example sparse codec 140 supporting both sparse encoding and sparse decoding, in accordance with various embodiments. The sparse codec 140 may be implemented as hardware or software, depending on the use case and preferences.

In some embodiments, the sparse codec 140 may be implemented inside the PE 140 illustrated in FIGS. 1A and 1B. More particularly, the sparse codec 140 may be implemented in the Sorting Engine (SE) in the PE 140 in FIG. 1B.

The sparse codec 140 may support both sparse encoding and sparse decoding, which are both essential in practice because they work together to optimize the efficiency of data storage, transmission, and processing, especially in large-scale applications like neural networks. Sparse encoding reduces the memory footprint and computational load by representing only the most significant data elements with high-precision, while compressing less critical data into a more efficient, low-precision format. This not only saves storage space but also speeds up data processing and reduces transmission latency. In practice, the sparsified tensor often needs to be restored to its dense format for several reasons. First, many neural network operations and algorithms are designed to work on dense tensors, requiring the full data structure to be present for correct functioning. Second, many hardware processing units or accelerators require the input tensor to be dense, thus the sparse representation needs to be restored (sparse decoded) to its original dense form to be compatible with these hardware apparatuses. Lastly, certain downstream tasks, such as visualization, analysis, or further processing, may require the dense format to ensure the full integrity and interpretability of the data.

In some embodiments, during the sparse encoding process 150 (denoted as Sparse Encode in FIG. 2A), dense data 152, such as a dense weight tensor or an activation tensor (where “dense” refers to a tensor containing a mix of both high-magnitude values with greater absolute values and low-magnitude values with smaller absolute values), is input into the sparse codec 140. The sparse codec 140 then generates a sparse representation 151 of the dense data 152. The sparse encoding process 150 prioritizes the retention of high-magnitude values due to their greater contribution to the computation accuracy of the neural network, while pruning less critical low-magnitude values to reduce memory footprint and computational cost.

In some embodiments, the sparse representation 151 of the dense data 152 may include condensed data 154 (e.g., a condensed sub-tensor) that gathers (aggregates) and compresses (e.g., through quantization) the high-magnitude values into a condensed tensor form. Quantizing the high-magnitude values in the condensed data 154 offers technical benefits by reducing the memory footprint and accelerating computation, as fewer bits are used to represent each value. The number of bits used to represent one tensor data is called bit-depth. For instance, each piece of tensor data in the original dense data 152 may use 32 bits, whereas each quantized tensor data in the condensed data 154 may use 8 bits. This way, the gathering operation may compress an original data of 64 bytes (assuming the dimension size of the tensor is 16, i.e., 16*32 bits is 64 bytes) to 16 bytes (16*8bits=16 bytes), saving the memory footprint by 4 times. This leads to faster processing and lower power consumption, which are particularly advantageous in energy-constrained environments like mobile devices or embedded systems. Additionally, quantization decreases the bandwidth needed for data transfer, improving the efficiency of hardware utilization, especially in systems optimized for lower-precision operations.

In some embodiments, the sparse representation 151 of the dense data 152 may further include a sparse bitmask 155 that represents the positions of the high-magnitude tensor data within the original dense data 152, as well as quantized low-magnitude tensor data from the original dense data 152. This sparse bitmask 155 is necessary for restoring the sparse representation 151 of the original tensor 152 to its original dense format, as it specifies where to place the high-magnitude tensor data from the condensed data 154 and what the low-precision values should be reintroduced.

Traditional bitmasks typically use a single bit per entry to indicate a binary choice: whether a position contains a pruned or non-pruned value. However, to facilitate the subsequent sparse decoding process, the bitmask needs to convey more than just the binary information. In some embodiments, each entry in the sparse bitmask 155 may utilize two or more bits, with the first bit serving as a sign bit. This design allows each entry in the sparse bitmask 155 to not only differentiate between pruned and non-pruned values but also to specify a range of quantized tensor data. For example, using two bits per entry in the sparse bitmask 155 provides four possible states, with one state representing the presence of a high-magnitude tensor data, and each of the other three states representing a different value range for a low-magnitude tensor data. This design allows to use the same data format, i.e., the sparse bitmask 155, to assist in reconstructing a more accurate dense tensor.

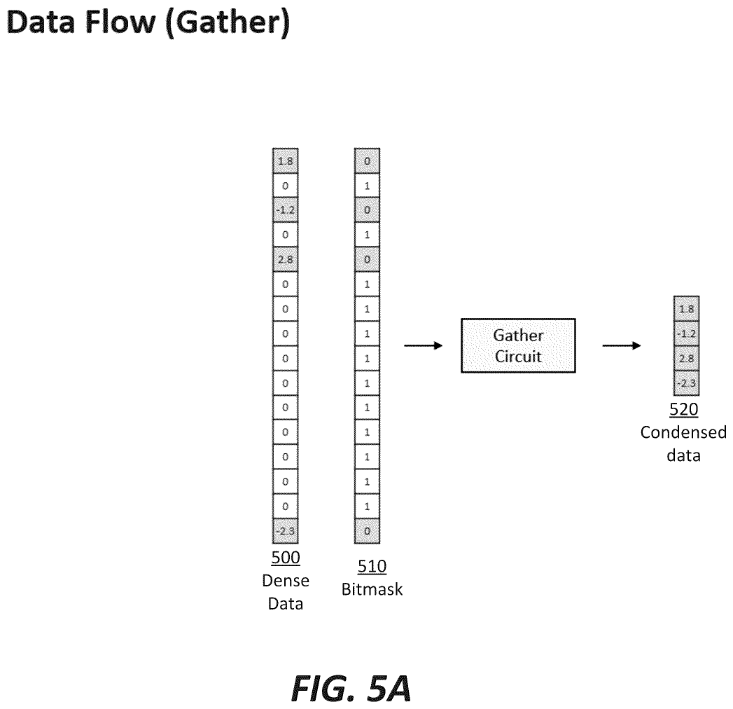

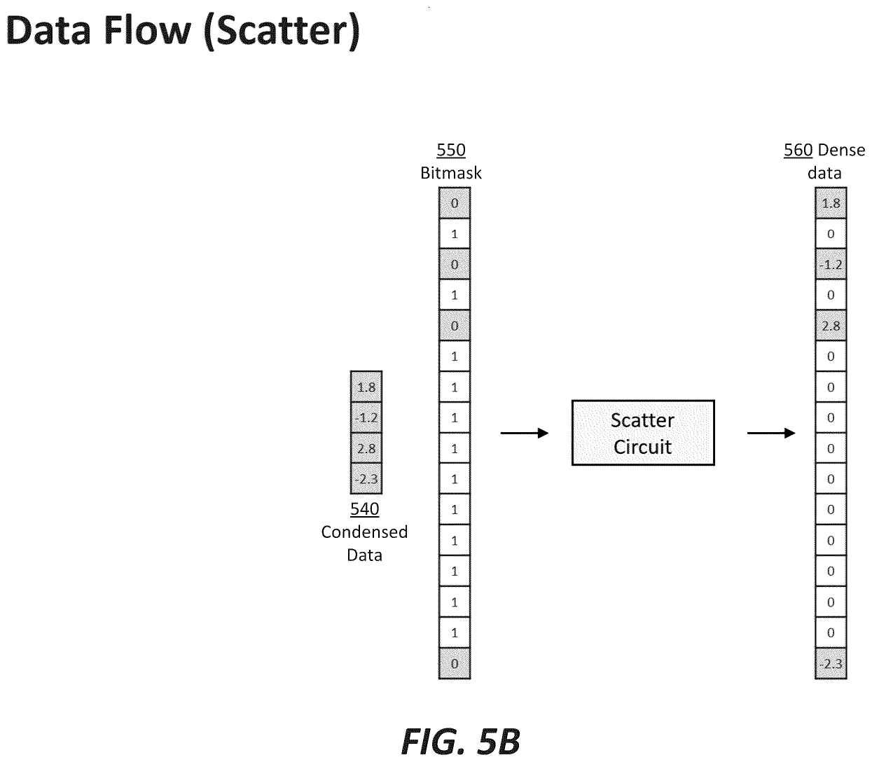

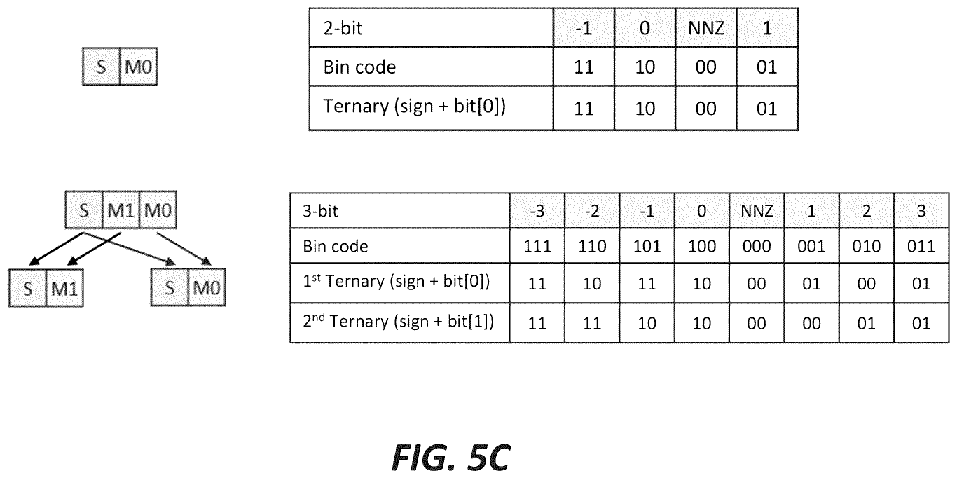

Furthermore, the sparse representation 151 of the dense data 152 may include quantization parameters 156 (denoted as Quant Params in FIG. 2A). These quantization parameters 156 are determined during the sparse encoding process 150 to quantize both the high-magnitude and low-magnitude tensor data in the dense data 152. Since the value ranges of high-magnitude and low-magnitude tensor data differ, two distinct sets of quantization parameters 156 may be generated respectively for each category. If the tensor data in the dense data 152 have been quantized (resulting in the condensed data 154 and the sparse bitmask 155), these quantization parameters 156 may be included as part of the sparse representation 151 of the dense data 152 and subsequently utilized during the sparse decoding process. For instance, the quantization parameters 156 may be applied to a quantized high-magnitude value in the condensed data 154 to generate a dequantized value close to its original high-magnitude value in the dense data 152. As another example, the quantization parameters 156 may be applied to a multi-bit entry in the sparse bitmask 155 (representing a quantized low-magnitude value) to dequantize the value into a corresponding low-magnitude value range. The dequantized values may be scattered into a dense tensor according to the sparse bitmask 155 to conclude the sparse decoding process. More details about the multi-bits bitmasks 155 are described in FIG. 5C.

In summary, the sparse encoding process 150 transforms the dense data 152 into a sparse representation 151, including one or more of the condensed data 154 representing the high-magnitude tensor data in the dense data 152, the sparse bitmask 155 representing the low-magnitude tensor data in the dense data 152, and quant params 156 preparing for sparse decoding process. This sparse representation 151 significantly reduces the memory footprint required for storage and minimizes the latency associated with transmitting the data from one PE to another, compared to handling the dense data 152 directly.

The sparse decoding process serves as the reverse operation of the sparse encoding process 150. During sparse decoding, the inputs may include one or more of the condensed data 154, the sparse bitmask 155, and the optional quantization parameters 156 if quantization occurred (or collectively, the sparse representation 151). At a high level, the sparse bitmask 155 is utilized to map the quantized high-magnitude values from the condensed data 154 back to their original positions within the dense data 152. If the sparse encoding process involves data quantization, the quantization parameters 156 play a crucial role in this decoding process by being used to dequantize the high-magnitude values in the condensed data 154 and the low-magnitude values in the sparse bitmask 155, thereby restoring these values as closely as possible to their original forms (e.g., precision and value) in the dense tensor. For instance, the multi-bit entries within the sparse bitmask 155, which represent the quantized low-precision values, are decoded back into their corresponding original high-precision values (with precision loss). Although the quantization process inherently reduces the precision of the original tensor data, the use of quantization parameters 156 allows the tensor data in the sparse representation 151 of the dense data 152 to be restored with an acceptable level of precision loss compared to the original values. This bidirectional sparsification process supported by the sparse codec 140 ensures that the sparse representation 151, while more efficient, still maintains a high degree of accuracy relative to the original dense data. The number of bits in the sparse bitmask 155 is inversely related to the loss of precision of the sparse encoding and decoding process, i.e., a higher bit-depth in the sparse bitmask 155 reduces the precision loss of the sparse encoding and decoding process.

During the sparse encoding process 150, the high-magnitude tensor data from the dense data 152 may be gathered into a condensed tensor. This gathering process may be implemented as a gather circuit, which is configured to transform a tensor (either sparse or dense) into a condensed tensor based on the given tensor mask (e.g., by gathering the high-magnitude tensor data into the condensed tensor). During the sparse decoding process, the high-magnitude tensor data in the condensed tensor need to be scatter back to their original positions in the dense data. This scattering process may be implemented as a scatter circuit, which is configured to transform the condensed tensor into a sparse uncondensed tensor based on a given bitmask by redistributing the high-magnitude tensor data to their original positions as indicated by the given bitmask, and filling the remaining positions with zero-valued elements. To complete the sparse decoding, the data in sparse uncondensed tensor may go through dequantization to restore the bit-depth of the dense tensor. The resultant tensor may be referred to as a restored dense tensor.

The presence of the gather circuit and the scatter circuit allows the sparse codec to perform sparse gather 160 and sparse scatter 170. During sparse gather 160, the uncondensed data 162 (e.g., a tensor with high-magnitude tensor data scattered at different positions) and a bitmask 163 (indicating the positions of the high-magnitude tensor data) may be received as input. The gather circuit in the sparse codec 140 may gather the high-magnitude tensor data in the uncondensed data 162 based on the bitmask 163 to generate the condensed data 164, which only contains the high-magnitude tensor data stored sequentially. In some embodiments, the bitmask 163 may be carried over as part of the output of the sparse gather 160, denoted as the bit mask 165. FIG. 5A illustrates an example sparse gather process in details.

During the sparse scatter 170 process, condensed data 164 and a bitmask 165 are received as inputs. The condensed data 164 contains only the high-magnitude tensor data that were retained after pruning the original dense tensor, while the bitmask 165 indicates the original positions of these high-magnitude values within the original dense tensor. The scatter circuit within the sparse codec 140 then redistributes the high-magnitude tensor data from the condensed data 164 back to their original positions in the tensor, guided by the bitmask 165. As a result, the scatter circuit generates an uncondensed data 162, which includes the high-magnitude tensor data restored to their original positions, with all other positions filled with zero tensor data. FIG. 5B illustrates an example sparse scatter process in details.

FIG. 2B illustrates an example system diagram of a PE incorporating a sparse codec module 250, in accordance with various embodiments.

For clarity, the PE in FIG. 2B is depicted using two primary modules: a control module 200 and a sparse codec module 250. In essence, the control module 200 is responsible for initializing, configuring, and managing data flow within the sparse codec module 250, while the sparse codec module 250 executes data processing tasks as directed by the control module 200.

In some embodiments, the control module 200 includes various components designed to manage and direct neural network computations. These components may include an instruction queue configured to receive computation instructions, such as memory addresses for input tensors, the type of computation to be performed, and the destination memory address for storing the output tensor. The control module 200 also comprises local (engine) registers, which serve as the interface for configuring the sparse codec module 250, and an instruction parser for interpreting the instructions within the instruction queue. Additionally, the control module 200 includes a read/write controller that is used to get necessary data flow read/write control information from control/status registers(CSR) or instructions, a pipeline instruction buffer that acts as a staging area for buffering instructions, local registers that materialize the configurations specified by the engine, and pipeline controller responsible for executing the instructions fetched from the pipeline instruction buffer.

In some embodiments, the sparse codec module 250 includes a plurality of hardware components and circuits to implement both the sparse encoding data path and the sparse decoding data path. These hardware components and circuits may include a shared memory 240, an input value buffer 252, a quant param (quantization parameter) circuit 251, an input mask buffer 253, a mask generation circuit 254 (denoted as Mask Gen in FIG. 2B), an output mask buffer 256, an input quant buffer 255, an output quant buffer 257, a gather circuit 260, a scatter circuit 270, an output value buffer 258, and other circuits and multiplexers for implementing supporting functionalities.

The input value buffer 252 is configured to receive the input tensor from the shared memory 240 as the input for the sparse codec module 250. The input tensor may be in different formats for sparse encoding and sparse decoding.

For instance, the input tensor received by the input value buffer 252 for sparse encoding may include a dense tensor, which contains any combination of high-magnitude and low-magnitude tensor data. The goal of the sparse encoding is to generate (1) a condensed tensor that gathers the high-magnitude tensor data (with quantization) and (2) a lightweight bitmask representing the low-magnitude tensor data (with quantization) and the position information of the high-magnitude tensor data in the original dense tensor. In some embodiments, quantization is performed during the sparse encoding process, and the quantization parameters may be part of the output of the sparse encoding. The condensed tensor, the lightweight bitmask, and the quantization parameters may be collectively called the sparse representation of the input dense tensor.

The quant param circuit 251 is used in the sparse encode data path of the sparse codec to quantize the tensor data in the input tensor. In some embodiments, the quant param circuit 251 may include a sorting circuit (e.g., the odd-even merge sort in FIG. 2B, or another type of circuit for sorting the tensor data) to determine the quantization ranges, e.g., the max and min values for the low-magnitude tensor data and for the high-magnitude tensor data. The quantization ranges are then used to determine the quantization bias and scale parameters. These quantization parameters are stored in the output quant buffer 257 as part of the sparse representation of the input tensor. These quantization parameters may be used to perform the quantization on the high-magnitude tensor data and the low-magnitude tensor data in the input tensor.

The mask generation circuit 254 may work with the quantization parameter circuit (specifically, the sorting circuit of the quantization parameter circuit) to generate a temporary bitmask indicating the positions of the high-magnitude tensor data in the input tensor. The temporary bitmask generated by the mask generation circuit 254 may be used by the gather circuit 260 to gather the quantized high-magnitude tensor data into a condensed tensor. The condensed tensor is a compact tensor containing only the quantized high-magnitude tensor data, which are stored in the output value buffer 258. The temporary bitmask may also be combined with the quantized low-magnitude tensor data to generate the sparse bitmask stored in the output mask buffer 256. The sparse bitmask includes (1) position information of the high-magnitude tensor data and (2) the quantized low-magnitude tensor data, each represented by two or more bits.

The sparse representation has a significantly smaller memory footprint than the dense tensor for several reasons. First, the condensed tensor contains quantized high-magnitude tensor data, which are represented with a reduced bit-depth (e.g., an original tensor data using 32 bits is compressed to 8 bits with a 4× compression rate). Second, the lightweight bitmask may use only a few bits (two or more) to encode the position information of both the quantized high-magnitude tensor data and the quantized low-magnitude tensor data, further reducing the bit-depth required for each entry in the bitmask. In some embodiments, the bit-depth of the condensed tensor is greater than the bit-depth of the bitmask but smaller than the bit-depth of the original dense tensor. This approach balances the need to maintain a certain level of precision for high-magnitude data in the condensed tensor—ensuring accurate computation by using high-precision storage—while allowing the precision of low-magnitude data in the bitmask to be reduced, thereby saving additional memory (trading off precision for increased memory efficiency). Consequently, the condensed tensor may be referred to as a high-precision (HP) tensor, while the bitmask may be referred to as a low-precision (LP) bitmask, reflecting their respective data precision levels.

For sparse decoding, the input to the sparse codec module 250 may include a condensed tensor, a lightweight bitmask, and quantization parameters from the shared memory 240. The output of the sparse decoding may include an approximation of the original dense tensor (e.g., the original dense tensor before passing through the sparse encoding process). The condensed tensor may be received by the input value buffer 252, the lightweight bitmask (also called the sparse bitmask) may be received by the input mask buffer 253, and the quantization parameters may be received by the input quant buffer 255. The quantized high-magnitude tensor data in the condensed tensor may be dequantized using the quantization parameters to approximate their original values with controlled precision loss. The quantized low-magnitude tensor data in the lightweight bitmask may also be dequantized using the quantization parameters to approximate their original values with controlled precision loss. The dequantization of the tensor data may increase the bit-depth to represent each value. For instance, the dequantized high-magnitude tensor data and the dequantized low-magnitude tensor data may have the same bit-depth as that of the original dense tensor. Then, the scatter circuit 270 may redistribute the dequantized high-magnitude and low-magnitude values to their original positions as an uncondensed tensor based on the lightweight bitmask. The uncondensed tensor is the approximation of the original dense tensor. The uncondensed tensor may be stored in the output value buffer 258.

In some embodiments, the PE may further include a transmitter to transmit the sparse representation of the dense data (i.e., the output of the sparse encoding of the dense data) to another PE in the same PE array for neural network computation or sparse decoding, or to a Sparse Processing Unit (SPU) for neural network computation. Since the sparse representation of the dense data consumes data transmission bandwidth and uses smaller memory space, the data transmission and computation using the sparse representation of the dense data is less costly than directly use the dense data.

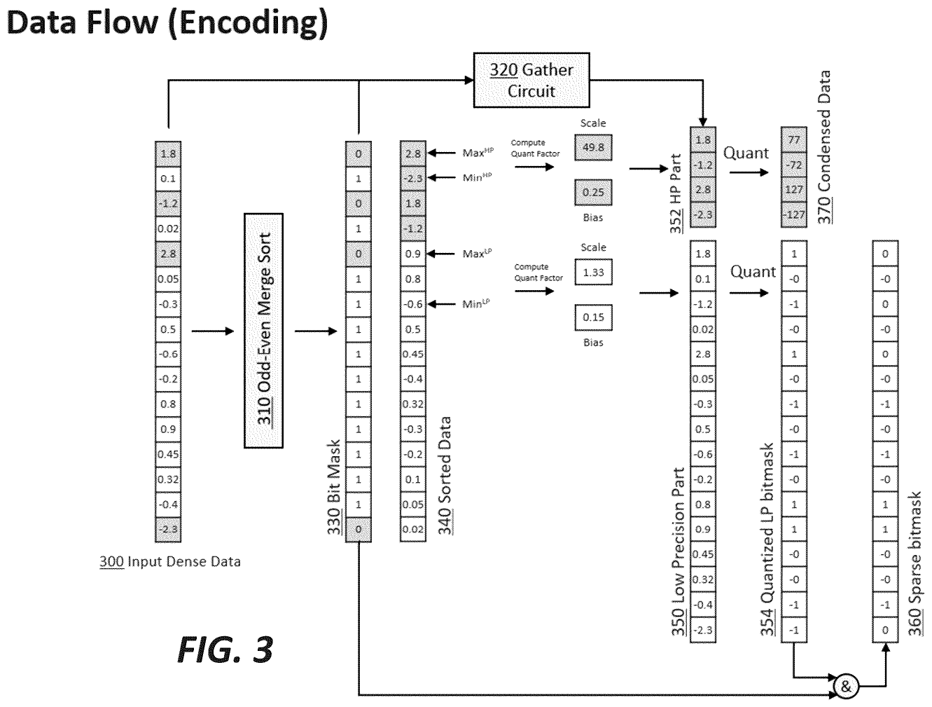

FIG. 3 illustrates a sparse encoding process using the PE with the sparse codec, in accordance with various embodiments. The sparse encoding process illustrated in FIG. 3 may be implemented using the sparse codec module 250 in FIG. 2B.

The sparse encoding process may start with receiving an input dense data 300, which includes a plurality of tensor data with different magnitudes. The input dense data 300 may go through a sorting circuit, such as an odd-even merge sort 310 circuit, to obtain sorted data 340. In some embodiments, the odd-even merge sort 310 is preferred in this context is because it works particularly well in parallel computing environments. Since the odd-even merge sort circuit may include a plurality of nodes to perform the sorting in parallel, the odd-even merge sort 310 circuit is structured to efficiently handle the sorting task by dividing the data into smaller subproblems, which can be solved simultaneously by the plurality of nodes.

As illustrated in FIG. 3, the sorted data 340 splits the high-magnitude tensor data and the low-magnitude tensor data. Note that the tensor data are sorted by their absolute magnitudes, as these magnitudes play a crucial role in neural network computations. The purposes of the sorting step include identifying the high-magnitude tensor data that are greater than a threshold value, and determining the parameters for the subsequent quantization.

For instance, the sorted data 340 may be used to generate a temporary bitmask 330 to indicate the original positions of the high-magnitude tensor data in the input dense data 300. Traditional bitmask usually uses 1s to indicate the positions of the high-magnitude tensor data and 0s to indicate the low-magnitude tensor data (those to be pruned out). In contrast, the bitmask 330 in FIG. 3 uses 0s to indicate the high-magnitude tensor data and 1s to indicate the low-magnitude tensor data. This reverse marking design is to facilitate the subsequent bitmask merging operations, which saves one round of bit-flipping when merging the temporary bitmask 330 with the quantized LP (low-precision) bitmask 354 to generate the sparse bitmask 360 (corresponding to the low-magnitude tensor data) as a part of the sparse encoding output.

Based on the temporary bitmask 330, the gather circuit 320 may gather the high-magnitude tensor data into the HP part 352, which will be used to generate the condense data 370 as another part of the sparse encoding output.

Using the sorted data 340, the max high-magnitude tensor data and the min high-magnitude tensor data may be determined as the range for quantizing the high-magnitude tensor data, and the max low-magnitude tensor data and the min low-magnitude tensor data may be determined as the range for quantizing the low-magnitude tensor data. Based on the max high-magnitude tensor data and the min high-magnitude tensor data, a scale and bias for the high-magnitude tensor data may be determined. Based on the max low-magnitude tensor data and the min low-magnitude tensor data, a scale and bias for the low-magnitude tensor data may be determined. These scale and bias factors may be used to quantize the high-magnitude tensor data in the HP part 352 and the LP part 350 (denoted as Low Precision Part in FIG. 3), to generate the condensed data 370 and the quantized LP bitmask 354, respectively.

In addition to the reverse marking design of the temporary bitmask 330, several additional implementation details contribute to improved encoding efficiency of the sparse codec. For example, the sparse bitmask 360 has the same number of entries as the input dense data, encompassing bits corresponding to both the low-magnitude and high-magnitude tensor data. This design allows the same bitmask to retain both (1) the position information of the quantized high-magnitude values (which are not pruned) and (2) the original value information of the quantized low-magnitude values (which will be pruned). For instance, two or more bits may be used to represent each entry in the sparse bitmask 360, with the first bit serving as the sign bit. In FIG. 3, “−0” (e.g., two-bits representation 10b) and “0” (e.g., two-bits representation 00b) in the sparse bitmask 360 convey different information. For example, “−0” may correspond to a quantized low-magnitude tensor data, while “0” indicates the position of a high-magnitude tensor data. During decoding, the “−0” bits will be dequantized to restore an approximated low-magnitude value, whereas the “0” bits will be used to place the dequantized high-magnitude value.

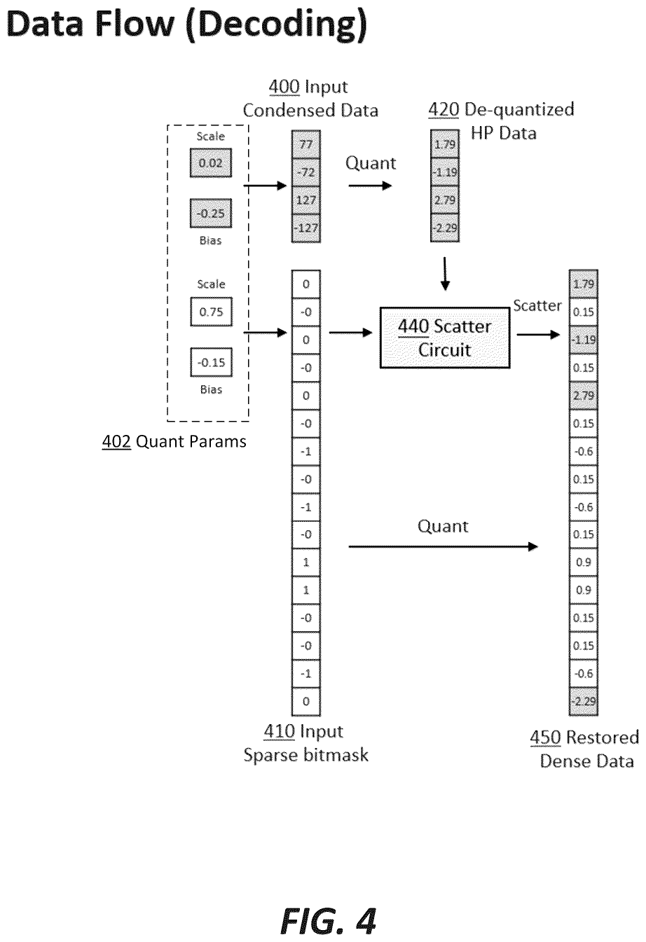

FIG. 4 illustrates a sparse decoding process using the PE with the sparse codec, in accordance with various embodiments. The sparse decoding process illustrated in FIG. 4 may be implemented using the sparse codec module 250 in FIG. 2B.

As a reverse process of the sparse encoding illustrated in FIG. 3, the sparse decoding workflow may start with receiving input data: an input condensed data 400 containing quantized high-magnitude values, an input sparse bitmask 410 containing the quantized low-magnitude values as well as position information of the high-magnitude values, and quant params 402 containing the quantization parameters.

The quant params 402 may include a first set of HP quantization parameters (including a scale and a bias) for the condensed data 400, and a second set of LP quantization parameters for the input sparse bitmask 410. These two sets of quantization parameters may be applied to the input condensed data 400 and the input sparse bitmask 410 to reverse the quantization. As a result, a dequantized HP data 420 (still in a condensed tensor format) and a dequantized sparse bitmask may be generated. The dequantized HP data 420 may include HP representation (high bit-depth) of the dequantized high-magnitude (value) tensor data. The dequantized sparse bitmask may include HP representation of the dequantized low-magnitude tensor data. Here, the HP representation means using a high bit-depth to represent each tensor data.

The scatter circuit 440 may scatter the quantized high-magnitude values in the input condensed data 400 into a sparse uncondensed tensor based on the position information in the input sparse bitmask 410. The remaining positions in the sparse uncondensed tensor may be filled with zeros. In particular, the scatter circuit 440 may redistribute (scatter) the dequantized HP tensor data into the uncondensed tensor based on the position information of in the input sparse bitmask 410.

Then, the sparse uncondensed tensor generated by the scatter circuit 440 may be merged with the dequantized low-magnitude tensor data to generate the restored dense data 450. In particular, the dequantized low-magnitude data may replace the corresponding zeros filled by the scatter circuit 440.

As shown in FIG. 4, the dequantized high-magnitude data are scatter across the restored dense data 450 to their original positions. The other positions in the restored dense data 450 may contain the dequantized low-magnitude tensor data.

The output of the sparse decoding process may inevitably experience some loss of data precision due to the quantization and dequantization steps, as well as the use of a reduced bit-depth to represent low-magnitude tensor data in the bitmask. However, the precision loss for high-magnitude tensor data stems mainly from the quantization and dequantization process. In contrast, the precision loss for low-magnitude tensor data may be relatively more significant, arising from both the quantization & dequantization process and the reduced bit-depth used in the bitmask. Nevertheless, this trade-off is justified, as low-magnitude tensor data are less critical for neural network computations. The resulting low-precision storage saves memory footprint, computation cost, and transmission latency, which outweighs the precision loss in low-magnitude tensor data.

FIGS. 5A and 5B illustrate exemplary gather and scatter processes using the PE with the sparse codec, in accordance with various embodiments. During the gather process illustrated in FIG. 5A, dense data 500 and a bitmask 510 may be input into the gather circuit. The dense data 500 includes high-magnitude tensor data and low-magnitude tensor data, and the bitmask 510 is determined after sorting the dense data 500 and identifying the positions of the high-magnitude tensor data. The gather circuit may gather the high-magnitude tensor data from the dense data 500 based on the bitmask 510, and generate the condensed data 520 only containing the high-magnitude tensor data.

During the scattering process illustrated in FIG. 5B, the input includes condensed data 540 that only contains the high-magnitude tensor data, and a bitmask 550 indicating the positions of the high-magnitude tensor data in the original dense data. The scattering circuit may then redistribute the high-magnitude tensor data back to their original positions and restore the dense data 560. Note that the bitmask 550 in FIG. 5B uses reverse marking by marking low-magnitude values as 1s, whereas the dense data 560 uses 0s to represent the low-magnitude tensor data.

FIG. 5C illustrate an example data format of the bitmask of the sparse codec, in accordance with various embodiments. As explained above, the specific design of the bitmasks in this disclosure uses the same data format to carry multiple pieces of information, which improves the efficiency of the sparse encoding and decoding processes. In particular, instead of using single bits in the bitmask to only differentiate high-magnitude P tensor data and low-magnitude tensor data, the bitmask in this disclosure uses two or more bits, including a sign bit and subsequent value bit(s).

The top section of FIG. 5C illustrates a two-bits bitmask, in which the first bit is the sign bit, and the second bit (M0) is the value bit. With these two bits, four different values may be represented. For instance, the high-magnitude tensor data (denoted as NNZ in FIG. 5C) may be represented using 00b (i.e., “0”), and the entries in the bitmask with 00b correspond to the positions of high-magnitude tensor data. The bits 11b (i.e., “−1”), 10b (i.e., “−0”), and 01b (“1”) in the bitmask represent three different quantization values of the low-magnitude tensor data.

The bottom section of FIG. 5C illustrates a three-bits bitmask, in which the first bit is the sign bit, and the following two bits M1 and M0 are the value bits. A person skilled in the art would use all three bits for each entry in the bitmask to represent 8 different values. However, the inventors of the present disclosure further exploit the potential of the three bits by combining the sign bit with each of the two values bits, forming a pair of two-bits representations. This way, multi-ternary representation may be achieved, and the three-bits representation can now be used to carry 16 different values. For instance, the bin code 110b (“−2”) may have a first ternary value of 10b and a second ternary value of 11b. Each bin code in this case may carry two different ternary values.

This pattern can be extended to 5-bits bitmasks, using the first bit as the sign bit, combining with each of the subsequent bits to form the multi-ternary representations.

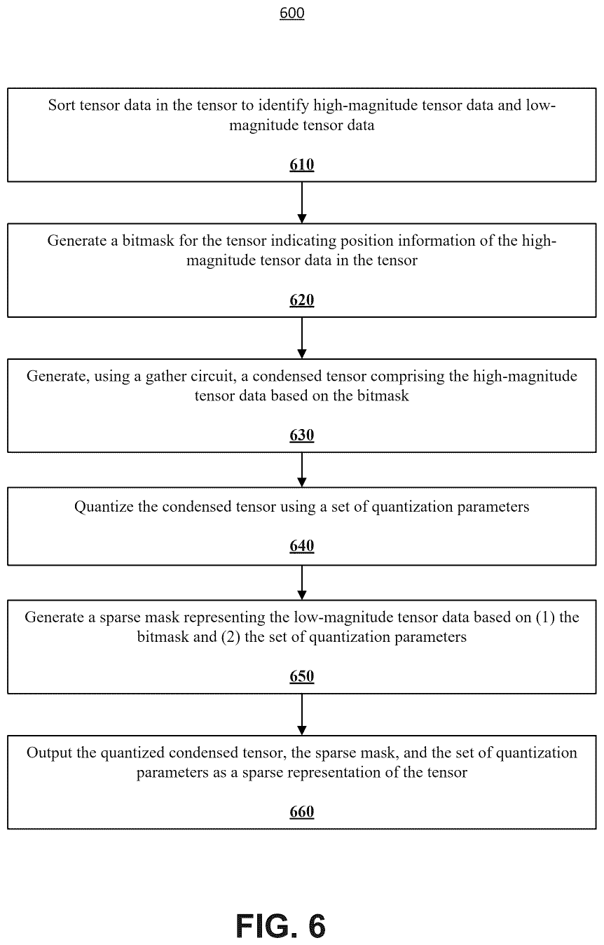

FIG. 6 illustrate an example process 600 of sparse encoding using the sparse codec, in accordance with various embodiments. In some implementations, one or more process blocks of FIG. 6 may be performed by a device.

As shown in FIG. 6, process 600 may include sorting tensor data in the tensor to identify high-magnitude tensor data and low-magnitude tensor data (block 610). For example, the device may sort tensor data in the tensor to identify high-magnitude tensor data and low-magnitude tensor data, as described above.

As also shown in FIG. 6, process 600 may include generating a bitmask for the tensor indicating position information of the high-magnitude tensor data in the tensor (block 620). For example, the device may generate a bitmask for the tensor indicating position information of the high-magnitude tensor data in the tensor, as described above.

As further shown in FIG. 6, process 600 may include generating, using a gather circuit, a condensed tensor having the high-magnitude tensor data based on the bitmask (block 630). For example, the device may generate, using a gather circuit, a condensed tensor having the high-magnitude tensor data based on the bitmask, as described above.

As also shown in FIG. 6, process 600 may include quantizing the condensed tensor using a set of quantization parameters (block 640). For example, the device may quantize the condensed tensor using a set of quantization parameters, as described above.

As further shown in FIG. 6, process 600 may include generating a sparse mask representing the low-magnitude tensor data based on (1) the bitmask and (2) the set of quantization parameters (block 650). For example, the device may generate a sparse mask representing the low-magnitude tensor data based on (1) the bitmask and (2) the set of quantization parameters, as described above.

As also shown in FIG. 6, process 600 may include outputting the quantized condensed tensor, the sparse mask, and the set of quantization parameters as a sparse representation of the tensor (block 660). For example, the device may output the quantized condensed tensor, the sparse mask, and the set of quantization parameters as a sparse representation of the tensor, as described above.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

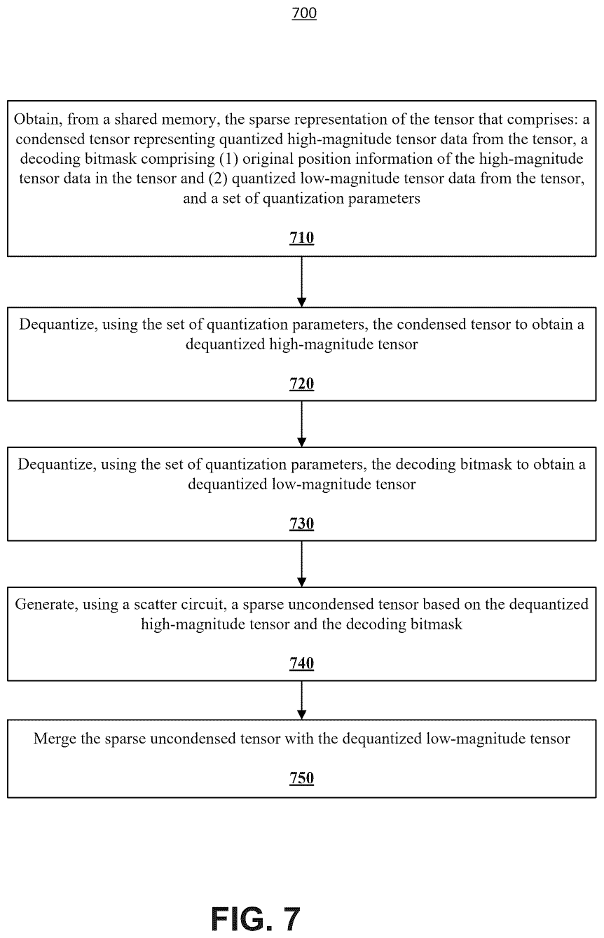

FIG. 7 illustrate an example process 700 of sparse decoding using the sparse codec, in accordance with various embodiments. In some implementations, one or more process blocks of FIG. 7 may be performed by a device.

As shown in FIG. 7, process 700 may include obtaining, from a shared memory, the sparse representation of the tensor that may include: a condensed tensor representing quantized high-magnitude tensor data from the tensor, a decoding bitmask having (1) original position information of the high-magnitude tensor data in the tensor and (2) quantized low-magnitude tensor data from the tensor, and a set of quantization parameters (block 710). For example, the device may obtain, from a shared memory, the sparse representation of the tensor that may include: a condensed tensor representing quantized high-magnitude tensor data from the tensor, a decoding bitmask having (1) original position information of the high-magnitude tensor data in the tensor and (2) quantized low-magnitude tensor data from the tensor, and a set of quantization parameters, as described above.

As also shown in FIG. 7, process 700 may include dequantizing, using the set of quantization parameters, the condensed tensor to obtain a dequantized high-magnitude tensor (block 720). For example, the device may dequantize, using the set of quantization parameters, the condensed tensor to obtain a dequantized high-magnitude tensor, as described above.

As further shown in FIG. 7, process 700 may include dequantizing, using the set of quantization parameters, the decoding bitmask to obtain a dequantized low-magnitude tensor (block 730). For example, the device may dequantize, using the set of quantization parameters, the decoding bitmask to obtain a dequantized low-magnitude tensor, as described above.

As also shown in FIG. 7, process 700 may include generating, using a scatter circuit, a sparse uncondensed tensor based on the dequantized high-magnitude tensor and the decoding bitmask (block 740). For example, the device may generate, using a scatter circuit, a sparse uncondensed tensor based on the dequantized high-magnitude tensor and the decoding bitmask, as described above.

As further shown in FIG. 7, process 700 may include merging the sparse uncondensed tensor with the dequantized low-magnitude tensor (block 750). For example, the device may merge the sparse uncondensed tensor with the dequantized low-magnitude tensor, as described above.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training samples to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually, or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A processor, comprising:
an input buffer configured to receive an input tensor;
a gather circuit configured to gather high-magnitude tensor data from a given dense tensor into a condensed tensor; and
a scatter circuit configured to scatter tensor data from a given condensed tensor into a sparse uncondensed tensor based on a given mask;
wherein the processor is configured to:
perform sparse encoding to generate a sparse representation of the input tensor, wherein the sparse representation comprises (1) the condensed tensor generated using the gather circuit based on the high-magnitude tensor data of the input tensor and (2) a sparse mask indicating position information of high-magnitude tensor data in the input tensor; and
perform sparse decoding to scatter the condensed tensor in the sparse representation into the sparse uncondensed tensor using the scatter circuit based on the sparse mask, wherein the sparse uncondensed tensor has same dimensions as the input tensor.

2. The processor of claim 1, wherein a memory footprint for storing the sparse representation of the input tensor is less than a memory footprint for storing the input tensor.

3. The processor of claim 2, wherein:
the high-magnitude tensor data in the condensed format is stored using a high bit-depth to achieve high-precision storage, and
the low-magnitude tensor data in the sparse mask is stored using a reduced bit-depth to achieve low-precision storage, trading off precision for increased memory efficiency.

4. The processor of claim 1, further comprising:
a transmitter configured to transmit the sparse representation of the input tensor to a Sparse Processing Unit (SPU) for neural network computation, or to another processor for computation or decoding.

5. The processor of claim 1, wherein the sparse representation further comprises quantization parameters used in encoding data in the input tensor.

6. The processor of claim 1, wherein during sparse encoding, the processor is further configured to:
sort tensor data in the input tensor to identify the high-magnitude tensor data and the low-magnitude tensor data;
generate a temporary bitmask indicating position information of the high-magnitude tensor data in the tensor;
determine a first set of quantization parameters for the high-magnitude tensor data, and a second set of quantization parameters for the low-magnitude tensor data;
generate, using the gather circuit, the condensed tensor comprising the high-magnitude tensor data quantized using the first set of quantization parameters;
generate the sparse mask representing the low-magnitude tensor data based on the temporary bitmask and the second set of quantization parameters; and
output the condensed tensor, the sparse mask, the first set of quantization parameters, and the second set of quantization parameters as the sparse representation of the tensor.

7. The processor of claim 6, wherein to generate the condensed tensor comprising the high-magnitude tensor data quantized using the first set of quantization parameters, the processor is further configured to:
feed the input tensor and the temporary bitmask to the gather circuit to gather the high-magnitude tensor data; and
quantize the high-magnitude tensor data by applying the first set of quantization parameters to the high-magnitude tensor data.

8. The processor of claim 6, wherein to generate the sparse mask representing the low-magnitude tensor data based on the temporary bitmask and the second set of quantization parameters, the processor is further configured to:
quantize the low-magnitude tensor data in the tensor by applying the second set of quantization parameters to the tensor to obtain a temporary tensor, wherein tensor data in the temporary tensor uses a reduced bit-depth than tensor data in the tensor; and
merge the temporary tensor with the temporary bitmask to obtain the bitmask representing the low-magnitude tensor data in the tensor.

9. The processor of claim 1, wherein the processor further comprises a quant buffer configured to receive quantization parameters, wherein:
the quantization parameters received by the quant buffer comprise a first set of quantization parameters corresponding to the condensed tensor, and a second set of quantization parameters corresponding to the sparse mask.

10. The processor of claim 9, wherein, during sparse decoding, the processor is further configured to:
dequantize the condensed tensor to obtain a dequantized high-magnitude tensor using the first set of quantization parameters;
dequantize the sparse mask to obtain a dequantized low-magnitude tensor using the second quantization parameters; and
feed the dequantized high-magnitude tensor and the dequantized low-magnitude tensor to the scatter circuit to obtain a restored version of the input tensor.

11. The processor of claim 10, wherein to dequantize the condensed tensor and the sparse mask, the processor is further configured to:
increase a bit-depth of tensor data in the condensed tensor and the sparse mask, wherein the increased bit-depth is same as a bit-depth of tensor data in the input tensor.

12. The processor of claim 1, wherein each entry in the sparse mask comprises two or more bits, with a first bit representing a sign of a corresponding tensor data, and the first bit is combined with each of subsequent bits of the two or more bits to implement multi-ternary representation of quantized tensor data.

13. A method for sparse encoding a tensor, comprising:
sorting tensor data in the tensor to identify high-magnitude tensor data and low-magnitude tensor data;
generating a bitmask for the tensor indicating position information of the high-magnitude tensor data in the tensor;
generating, using a gather circuit, a condensed tensor comprising the high-magnitude tensor data based on the bitmask;
quantizing the condensed tensor using a set of quantization parameters;
generating a sparse mask representing the low-magnitude tensor data based on (1) the bitmask and (2) the set of quantization parameters; and
outputting the quantized condensed tensor, the sparse mask, and the set of quantization parameters as a sparse representation of the tensor.

14. The method of claim 13, wherein the gather circuit is configured to gather high-magnitude tensor data from a given dense tensor into a condensed tensor.

15. The method of claim 13, wherein the generating the condensed tensor representing the high-magnitude tensor data comprises:
feeding the tensor and the bitmask to the gather circuit for gathering the high-magnitude tensor data based on the position information in the bitmask.

16. The method of claim 13, wherein the generating the sparse mask comprises:
quantizing the low-magnitude tensor data in the tensor by applying the set of quantization parameters to the tensor to obtain a temporary tensor, wherein tensor data in the temporary tensor uses a reduced bit-depth than tensor data in the tensor; and
merging the temporary tensor with the bitmask.

17. The method of claim 13, wherein a bit-depth of tensor data in the condensed tensor is higher than a bit-depth of tensor data in the bitmask, but lower than a bit-depth of tensor data in the tensor.

18. The method of claim 13, wherein each entry in the sparse mask comprises two or more bits, with a first bit representing a sign of a corresponding tensor data.

19. The method of claim 18, wherein the first bit is combined with each of subsequent bits of the two or more bits to implement multi-ternary representation of quantized tensor data.

20. A method for sparse decoding a sparse representation of a tensor, comprising:
obtaining, from a shared memory, the sparse representation of the tensor that comprises:
a condensed tensor representing quantized high-magnitude tensor data from the tensor,
a decoding bitmask comprising (1) original position information of the high-magnitude tensor data in the tensor and (2) quantized low-magnitude tensor data from the tensor, and
a set of quantization parameters;
dequantizing, using the set of quantization parameters, the condensed tensor to obtain a dequantized high-magnitude tensor;
dequantizing, using the set of quantization parameters, the decoding bitmask to obtain a dequantized low-magnitude tensor;
generating, using a scatter circuit, a sparse uncondensed tensor based on the dequantized high-magnitude tensor and the decoding bitmask;
merging the sparse uncondensed tensor with the dequantized low-magnitude tensor.
